(19) United States
(12) Patent Application Publication
(10) Pub. No.: US 2025/0071819 A1
(43) Pub. Date: Feb. 27, 2025

(54) METHOD AND APPARATUS FOR IDENTIFYING TIME ADJUSTMENT GROUPS IN MULTIPLE TRANSMISSION AND RECEPTION POINT ENVIRONMENT

(71) Applicant: ELECTRONICS AND TELECOMMUNICATIONS RESEARCH INSTITUTE, Daejeon (KR)

(72) Inventors: Kapseok CHANG, Daejeon (KR); Yong Sun KIM, Daejeon (KR); Young Jo KO, Daejeon (KR)

(73) Assignee: ELECTRONICS AND TELECOMMUNICATIONS RESEARCH INSTITUTE, Daejeon (KR)

(21) Appl. No.: 18/814,108

(22) Filed: Aug. 23, 2024

(30) Foreign Application Priority Data
Aug. 23, 2023 (KR) 10-2023-0110620
Aug. 8, 2024 (KR) 10-2024-0105959

(51) Int. Cl. H04W 74/0833; H04W 24/10; H04W 74/00

(52) U.S. Cl. CPC H04W 74/0833; H04W 24/10; H04W 74/006

(57) ABSTRACT

A method of a mobile station (MS) according to an exemplary of the present disclosure may comprise: receiving a first SSB including a PBCH from a first TRP; receiving an SIB1 based on an MIB included in the PBCH; receiving second system information based on the SIB1; and performing an RA procedure with the first TRP based on the second system information, wherein the second system information includes information on SSB group(s) and mapping information of an SSB group to which the first TRP belongs, and the information on the SSB group(s) includes information on an SSB index transmitted by TRP(s) belonging to each of the SSB group(s).

### CROSS-REFERENCE TO RELATED APPLICATIONS

This application claims priority to Korean Patent Applications No. 10-2023-0110620, filed on Aug. 23, 2023, and No. 10-2024-0105959, filed on Aug. 8, 2024, with the Korean Intellectual Property Office (KIPO), the entire contents of which are hereby incorporated by reference.

### BACKGROUND

### 1. Technical Field

The present disclosure relates to a technique for time synchronization between a base station and a user equipment (UE) in a wireless communication system, and more particularly, to a technique for time synchronization between a base station and a UE in a multiple transmission and reception point (TRP) environment.

### 2. Related Art

With the development of information and communication technology, various wireless communication technologies have been developed. Typical wireless communication technologies include long term evolution (LTE) and new radio (NR), which are defined in the 3rd generation partnership project (3GPP) standards. The LTE may be one of 4th generation (4G) wireless communication technologies, and the NR may be one of 5th generation (5G) wireless communication technologies.

For the processing of rapidly increasing wireless data after the commercialization of the 4th generation (4G) communication system (e.g. Long Term Evolution (LTE) communication system or LTE-Advanced (LTE-A) communication system), the 5th generation (5G) communication system (e.g. new radio (NR) communication system) that uses a frequency band (e.g. a frequency band of 6 GHz or above) higher than that of the 4G communication system as well as a frequency band of the 4G communication system (e.g. a frequency band of 6 GHz or below) is being considered. The 5G communication system may support enhanced Mobile BroadBand (eMBB), Ultra-Reliable and Low-Latency Communication (URLLC), and massive Machine Type Communication (mMTC).

Meanwhile, in a wireless communication system, a method of communicating with a terminal by utilizing transmission and reception points (TRPs) is provided for the purpose of expanding a base station's coverage. In this case, the terminal may communicate with multiple TRPs. To enable communication with multiple TRPs, the terminal may need to perform a connection procedure with another TRP while being connected to one TRP. During the process of connecting to a second TRP, a time synchronization between the terminal and a first TRP may not align with a time synchronization between the terminal and the second TRP. Therefore, a method and apparatus for aligning the time synchronization between the terminal and multiple TRPs are required.

### SUMMARY

The present disclosure for resolving the above-described problems is directed to providing a method and an apparatus for acquiring synchronization between a UE communicating with multiple TRPs and each TRP in a multi-TRP environment.

A method of a mobile station (MS), according to an exemplary embodiment of the present disclosure for achieving the above-described objective, may comprise: receiving a first synchronization signal block (SSB) including a physical broadcast channel (PBCH) from a first transmission and reception point (TRP); receiving a system information block (SIB1) based on a master information block (MIB) included in the PBCH; receiving second system information based on the SIB1; and performing a random access (RA) procedure with the first TRP based on the second system information, wherein the second system information may include information on SSB group(s) and mapping information of an SSB group to which the first TRP belongs, and the information on the SSB group(s) may include information on an SSB index transmitted by TRP(s) belonging to each of the SSB group(s).

The second system information may further include information on a timing advance (TA) offset for each of the SSB group(s).

The method may further comprise: receiving a radio resource control (RRC) configuration message from the first TRP; and transmitting an RRC configuration complete message to the first TRP in response to the RRC configuration message, wherein the RRC configuration message may include SSB group mapping relationship information for the first TRP and adjacent TRPs.

The RRC configuration message may further include information on a TA offset for each of the SSB group(s).

The method may further comprise: receiving a measurement report request message from the first TRP; measuring reception signal strength(s) of signal(s) received from TRP(s) adjacent to the first TRP based on the measurement report request message; transmitting, to the first TRP, a measurement report message including the measured reception signal strength(s) of the signal(s) received from the adjacent TRP(s) and information of the adjacent TRP(s); receiving, from the first TRP, a physical downlink control channel (PDCCH) order instructing to connection to a second TRP, which is one of the adjacent TRP(s); and performing an RA procedure with the second TRP based on the PDCCH order.

The adjacent TRP(s) may include at least one of information on cell(s) of the adjacent TRP(s), information on SSB group(s) of the adjacent TRP(s), or information on a difference between a time of receiving the first SSB from the first TRP and a time of receiving an SSB from each of the adjacent TRP(s).

The PDCCH order may include at least one of information on a resource used to access the second TRP or information on a TA offset for the second TRP.

In the RA procedure with the second TRP, an RA preamble may be transmitted based on the information on the TA offset for the second TRP.

A mobile station (MS), according to an exemplary embodiment of the present disclosure, may comprise a processor, and the processor may cause the MS to perform: receiving a first synchronization signal block (SSB) including a physical broadcast channel (PBCH) from a first transmission and reception point (TRP); receiving a system information block (SIB1) based on a master information block (MIB) included in the PBCH; receiving second system information based on the SIB1; and performing a random access (RA) procedure with the first TRP based on the second system information, wherein the second system information may include information on SSB group(s) and mapping information of an SSB group to which the first TRP belongs, and the information on the SSB group(s) may include information on an SSB index transmitted by TRP(s) belonging to each of the SSB group(s).

The second system information may further include information on a timing advance (TA) offset for each of the SSB group(s).

The processor may cause the MS to perform: receiving a radio resource control (RRC) configuration message from the first TRP; and transmitting an RRC configuration complete message to the first TRP in response to the RRC configuration message, wherein the RRC configuration message may include SSB group mapping relationship information for the first TRP and adjacent TRPs.

The RRC configuration message may further include information on a TA offset for each of the SSB group(s).

The processor may cause the MS to perform: receiving a measurement report request message from the first TRP; measuring reception signal strength(s) of signal(s) received from TRP(s) adjacent to the first TRP based on the measurement report request message; transmitting, to the first TRP, a measurement report message including the measured reception signal strength(s) of the signal(s) received from the adjacent TRP(s) and information of the adjacent TRP(s); receiving, from the first TRP, a physical downlink control channel (PDCCH) order instructing to connection to a second TRP, which is one of the adjacent TRP(s); and performing an RA procedure with the second TRP based on the PDCCH order.

The information on the adjacent TRP(s) may include at least one of information on cell(s) of the adjacent TRP(s), information on SSB group(s) of the adjacent TRP(s), or information on a difference between a time of receiving the first SSB from the first TRP and a time of receiving an SSB from each of the adjacent TRP(s).

The PDCCH order may include at least one of information on a resource used to access the second TRP or information on a TA offset for the second TRP.

In the RA procedure with the second TRP, the processor may cause the MS to perform: transmitting an RA preamble based on the information on the TA offset for the second TRP.

A method of a base station (BS), according to an exemplary embodiment of the present disclosure, may comprise: transmitting a first synchronization signal block (SSB) including a physical broadcast channel (PBCH) through a first transmission and reception point (TRP) connected to the BS; transmitting a system information block (SIB1) based on a master information block (MIB) included in the PBCH; transmitting second system information based on the SIB1; and performing a random access (RA) procedure with a mobile station (MS) in an RA occasion based on the second system information, wherein the second system information may include information on SSB group(s) and mapping information of an SSB group to which the first TRP belongs, and the information on the SSB group(s) may include information on an SSB index transmitted by TRP(s) belonging to each of the SSB group(s).

The second system information may further include information on a timing advance (TA) offset for each of the SSB group(s), and a radio resource control (RRC) configuration message may include SSB group mapping relationship information for the first TRP and adjacent TRPs.

The method may further comprise: transmitting a radio resource control (RRC) configuration message to the MS through the first TRP; and in response to the RRC configuration message, receiving an RRC configuration complete message from the MS through the first TRP, wherein the RRC configuration message may further include information on a TA offset for each of the SSB group(s).

The method may further comprise: transmitting a measurement report request message to the MS through the first TRP; receiving a measurement report message from the MS through the first TRP; and transmitting a physical downlink control channel (PDCCH) order instructing the MS to connect to a second TRP through the first TRP based on the measurement report message, wherein the measurement report message may include information on adjacent TRP(s) of the first TRP and information on signal strength(s) of signal(s) received from the adjacent TRP(s), and the information on the adjacent TRP(s) may include at least one of information on cell(s) of the adjacent TRP(s), information on SSB group(s) of the adjacent TRP(s), or information on a difference between a time of receiving the first SSB from the first TRP and a time of receiving an SSB from each of the adjacent TRP(s).

According to exemplary embodiments of the present disclosure, in a multi-TRP environment, a terminal can perform communication without inter-symbol interference (ISI) and inter-carrier interference (ICI) during signal transmission and reception. When the terminal in the mTRP environment transmits and receives signals with different TRPs within the same cell, even with significant distance differences between the terminal and the TRPs, transmission and reception times of respective signals can be managed by group. This provides the advantage of preventing occurrence of ISI and ICI.

### BRIEF DESCRIPTION OF DRAWINGS

FIG. 1 is a conceptual diagram illustrating an exemplary embodiment of a communication system.

FIG. 2 is a block diagram illustrating an exemplary embodiment of a communication node constituting a communication system.

FIG. 3A is a conceptual diagram describing signal transmission between multiple TRPs and an MS within a cell.

FIG. 3B is a conceptual diagram describing signal transmission between inter-cell multiple TRPs and an MS.

FIG. 4A is a conceptual diagram describing intra-cell mTRP-based uplink and downlink transmission.

FIG. 4B is a conceptual diagram describing inter-cell mTRP-based uplink and downlink transmission.

FIG. 5 is a conceptual diagram describing a case where a TRP transmits SSBs in a beam sweeping scheme.

FIG. 6 is a conceptual diagram describing a case where TRPs are grouped into SSB groups in an mTRP environment.

FIG. 7A is a sequence chart describing a case where an MS accesses a first TRP in an mTRP environment.

FIG. 7B is a sequence chart describing a case where the MS accesses the second TRP while connected to the first TRP in an mTRP environment.

### DETAILED DESCRIPTION OF THE EMBODIMENTS

While the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, “at least one of A and B” may refer to “at least one A or B” or “at least one of one or more combinations of A and B”. In addition, “one or more of A and B” may refer to “one or more of A or B” or “one or more of one or more combinations of A and B”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

A communication system to which exemplary embodiments according to the present disclosure are applied will be described. The communication system to which the exemplary embodiments according to the present disclosure are applied is not limited to the contents described below, and the exemplary embodiments according to the present disclosure may be applied to various communication systems. Here, the communication system may have the same meaning as a communication network.

Throughout the present disclosure, a network may include, for example, a wireless Internet such as wireless fidelity (WiFi), mobile Internet such as a wireless broadband Internet (WiBro) or a world interoperability for microwave access (WiMax), 2G mobile communication network such as a global system for mobile communication (GSM) or a code division multiple access (CDMA), 3G mobile communication network such as a wideband code division multiple access (WCDMA) or a CDMA2000, 3.5G mobile communication network such as a high speed downlink packet access (HSDPA) or a high speed uplink packet access (HSUPA), 4G mobile communication network such as a long term evolution (LTE) network or an LTE-Advanced network, 5G mobile communication network, beyond 5G (B5G) mobile communication network (e.g. 6G mobile communication network), or the like.

Throughout the present disclosure, a terminal may refer to a mobile station, mobile terminal, subscriber station, portable subscriber station, user equipment, access terminal, or the like, and may include all or a part of functions of the terminal, mobile station, mobile terminal, subscriber station, mobile subscriber station, user equipment, access terminal, or the like.

Here, a desktop computer, laptop computer, tablet PC, wireless phone, mobile phone, smart phone, smart watch, smart glass, e-book reader, portable multimedia player (PMP), portable game console, navigation device, digital camera, digital multimedia broadcasting (DMB) player, digital audio recorder, digital audio player, digital picture recorder, digital picture player, digital video recorder, digital video player, or the like having communication capability may be used as the terminal.

Throughout the present specification, the base station may refer to an access point, radio access station, node B (NB), evolved node B (eNB), base transceiver station, mobile multihop relay (MMR)-BS, or the like, and may include all or part of functions of the base station, access point, radio access station, NB, eNB, base transceiver station, MMR-BS, or the like.

Hereinafter, preferred exemplary embodiments of the present disclosure will be described in more detail with reference to the accompanying drawings. In describing the present disclosure, in order to facilitate an overall understanding, the same reference numerals are used for the same elements in the drawings, and duplicate descriptions for the same elements are omitted.

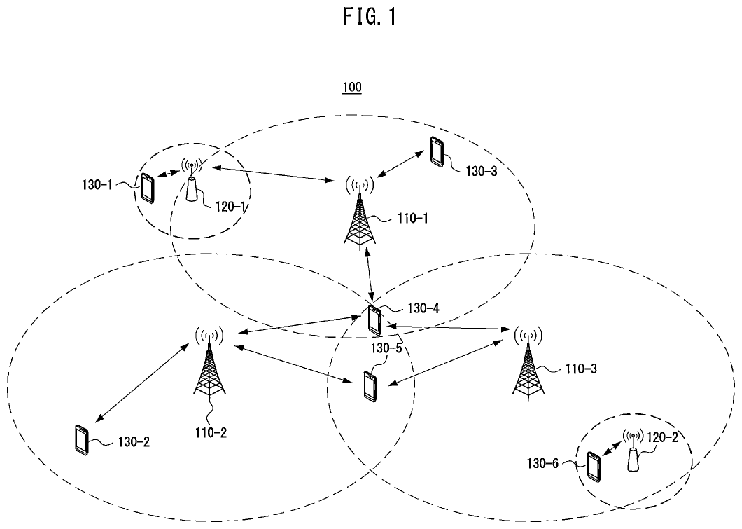

FIG. 1 is a conceptual diagram illustrating an exemplary embodiment of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. The plurality of communication nodes may support 4G communication (e.g. long term evolution (LTE), LTE-advanced (LTE-A)), 5G communication (e.g. new radio (NR)), 6G communication, etc. specified in the 3rd generation partnership project (3GPP) standards. The 4G communication may be performed in frequency bands below 6 GHz, and the 5G and 6G communication may be performed in frequency bands above 6 GHz as well as frequency bands below 6 GHz.

For example, in order to perform the 4G communication, 5G communication, and 6G communication, the plurality of communication may support a code division multiple access (CDMA) based communication protocol, wideband CDMA (WCDMA) based communication protocol, time division multiple access (TDMA) based communication protocol, frequency division multiple access (FDMA) based communication protocol, orthogonal frequency division multiplexing (OFDM) based communication protocol, filtered OFDM based communication protocol, cyclic prefix OFDM (CP-OFDM) based communication protocol, discrete Fourier transform spread OFDM (DFT-s-OFDM) based communication protocol, orthogonal frequency division multiple access (OFDMA) based communication protocol, single carrier FDMA (SC-FDMA) based communication protocol, non-orthogonal multiple access (NOMA) based communication protocol, generalized frequency division multiplexing (GFDM) based communication protocol, filter bank multi-carrier (FBMC) based communication protocol, universal filtered multi-carrier (UFMC) based communication protocol, space division multiple access (SDMA) based communication protocol, orthogonal time-frequency space (OTFS) based communication protocol, or the like.

Further, the communication system 100 may further include a core network. When the communication 100 supports 4G communication, the core network may include a serving gateway (S-GW), packet data network (PDN) gateway (P-GW), mobility management entity (MME), and the like. When the communication system 100 supports 5G communication or 6G communication, the core network may include a user plane function (UPF), session management function (SMF), access and mobility management function (AMF), and the like.

Meanwhile, each of the plurality of communication nodes 110-1, 110-2, 110-3, 120-1, 120-2, 130-1, 130-2, 130-3, 130-4, 130-5, and 130-6 constituting the communication system 100 may have the following structure.

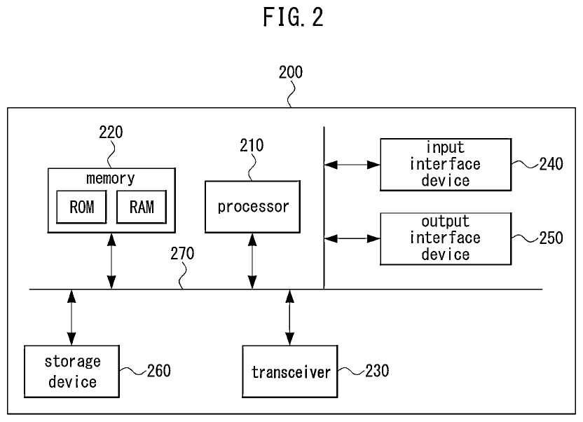

FIG. 2 is a block diagram illustrating an exemplary embodiment of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

However, each component included in the communication node 200 may not be connected to the common bus 270 but may be connected to the processor 210 via an individual interface or a separate bus. For example, the processor 210 may be connected to at least one of the memory 220, the transceiver 230, the input interface device 240, the output interface device 250 and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to cell coverage of the first base station 110-1. Also, the second terminal 130-2, the fourth terminal 130-4, and the fifth terminal 130-5 may belong to cell coverage of the second base station 110-2. Also, the fifth base station 120-2, the fourth terminal 130-4, the fifth terminal 130-5, and the sixth terminal 130-6 may belong to cell coverage of the third base station 110-3. Also, the first terminal 130-1 may belong to cell coverage of the fourth base station 120-1, and the sixth terminal 130-6 may belong to cell coverage of the fifth base station 120-2.

Here, each of the plurality of base stations 110-1, 110-2, 110-3, 120-1, and 120-2 may refer to a Node-B (NB), evolved Node-B (eNB), gNB, base transceiver station (BTS), radio base station, radio transceiver, access point, access node, road side unit (RSU), radio remote head (RRH), transmission point (TP), transmission and reception point (TRP), or the like.

Each of the plurality of terminals 130-1, 130-2, 130-3, 130-4, 130-5, and 130-6 may refer to a user equipment (UE), terminal, access terminal, mobile terminal, station, subscriber station, mobile station, portable subscriber station, node, device, Internet of Thing (IoT) device, mounted module/device/terminal, on-board device/terminal, or the like.

Meanwhile, each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul or a non-ideal backhaul, and exchange information with each other via the ideal or non-ideal backhaul. Also, each of the plurality of base stations 110-1, 110-2, 110-3, 120-1, and 120-2 may be connected to the core network through the ideal or non-ideal backhaul. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

In addition, each of the plurality of base stations 110-1, 110-2, 110-3, 120-1, and 120-2 may support multi-input multi-output (MIMO) transmission (e.g. a single-user MIMO (SU-MIMO), multi-user MIMO (MU-MIMO), massive MIMO, or the like), coordinated multipoint (CoMP) transmission, carrier aggregation (CA) transmission, transmission in an unlicensed band, device-to-device (D2D) communications (or, proximity services (ProSe)), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2, and operations supported by the plurality of base stations 110-1, 110-2, 110-3, 120-1, and 120-2. For example, the second base station 110-2 may transmit a signal to the fourth terminal 130-4 in the SU-MIMO manner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner.

The first base station 110-1, the second base station 110-2, and the third base station 110-3 may transmit a signal to the fourth terminal 130-4 in the COMP transmission manner, and the fourth terminal 130-4 may receive the signal from the first base station 110-1, the second base station 110-2, and the third base station 110-3 in the COMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner. Each of the base stations 110-1, 110-2, and 110-3 may control D2D communications between the fourth terminal 130-4 and the fifth terminal 130-5, and thus the fourth terminal 130-4 and the fifth terminal 130-5 may perform the D2D communications under control of the second base station 110-2 and the third base station 110-3.

Hereinafter, methods for configuring and managing radio interfaces in a communication system will be described. Even when a method (e.g. transmission or reception of a signal) performed at a first communication node among communication nodes is described, the corresponding second communication node may perform a method (e.g. reception or transmission of the signal) corresponding to the method performed at the first communication node. That is, when an operation of a terminal is described, a corresponding base station may perform an operation corresponding to the operation of the terminal. Conversely, when an operation of a base station is described, a corresponding terminal may perform an operation corresponding to the operation of the base station.

Meanwhile, in a communication system, a base station may perform all functions (e.g. remote radio transmission/reception function, baseband processing function, and the like) of a communication protocol. Alternatively, the remote radio transmission/reception function among all the functions of the communication protocol may be performed by a transmission and reception point (TRP) (e.g. flexible (f)-TRP), and the baseband processing function among all the functions of the communication protocol may be performed by a baseband unit (BBU) block. The TRP may be a remote radio head (RRH), radio unit (RU), transmission point (TP), or the like. The BBU block may include at least one BBU or at least one digital unit (DU). The BBU block may be referred to as a ‘BBU pool’, ‘centralized BBU’, or the like. The TRP may be connected to the BBU block through a wired fronthaul link or a wireless fronthaul link. The communication system composed of backhaul links and fronthaul links may be as follows. When a functional split scheme of the communication protocol is applied, the TRP may selectively perform some functions of the BBU or some functions of medium access control (MAC)/radio link control (RLC) layers.

Hereinafter, the present disclosure will describe methods and devices for time adjustment for a case where a specific node communicates with one TRP or two or more TRPs in an environment where two or more TRPs are connected to a single base station (BS). In addition, the present disclosure will describe methods and devices for time adjustment of uplink (UL) between a specific node and TRPs using a timing advance (TA) value for time adjustment.

In the present disclosure, a ‘BS’ may be referred to as, for example, an eNB of a 4G network, a gNB of a 5G network, or a base station with another name to be applied in a 6G network in the future. As another example, in the case of following the open radio access network (O-RAN) standards, a BS according to the present disclosure may be a centralized unit (CU). If a BS is configured as a CU according to the O-RAN standards, a TRP may be configured as a distributed unit (DU) or configured as a DU and a radio unit (RU).

In the present disclosure, a node communicating with a base station and/or TRP(s) may be referred to as a mobile station (MS). Here, the MS may also be referred to as a user equipment (UE) or a terminal, and may represent all equipment capable of communicating with TRP(s) and/or BS. In addition, in the present disclosure, it is assumed that a node directly communicating with the MS is a TRP. Therefore, the TRP may transmit and/or receive a wireless channel over the air with the MS under the control of the BS. In addition, a cell may refer to a communication range of TRP(s) controlled by the BS.

The MS, BS, and/or TRP may include at least some of the components of FIG. 2 described above, or may include all of the components of FIG. 2, or may include additional components in addition to the components of FIG. 2. If the MS has additional components, for example, the MS may further include various interfaces and/or sensors for user convenience. If the BS has additional components, the BS may further include an interface for communicating with TRP(s) or another BS (e.g. backhaul interface and/or fronthaul interface). In addition, the BS may further include an interface for communicating with a specific network function (NF) of a core network. The TRP may further include an interface for communicating with the BS. However, it should be noted that this is for convenience of description and is not limited thereto. All possible configurations according to the concept of the methods, procedures, and devices according to the present disclosure may be included in the scope of the present disclosure.

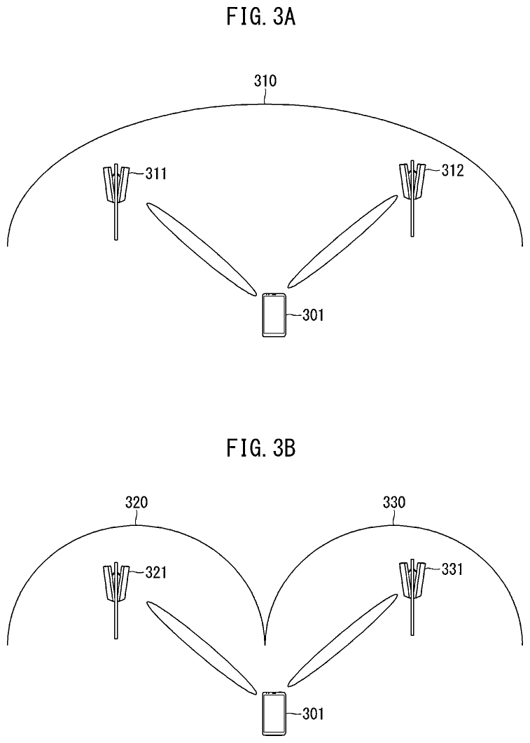

FIG. 3A is a conceptual diagram describing signal transmission between multiple TRPs and an MS within a cell.

Referring to FIG. 3A, a case is illustrated where two different TRPs 311 and 312 are included in a single cell 310. The single cell 310 may mean a communication area controlled by one BS (not shown in FIG. 3A) as described above. In order to distinguish each cell from other cells, each cell 310 may have a different physical cell identity (PCI). The PCI may be transmitted by the respective TRPs included in the BS and may be determined by a primary synchronization signal (PSS) and a secondary synchronization signal (SSS). The PSS and SSS may be transmitted together with a physical broadcast channel (PBCH). The PSS, SSS, and PBCH may be referred to as a synchronization signal block (SSB). As another example, the PSS and SSS may be referred to as synchronization signals (SS), and the PBCH may be referred to separately. In this case, since the synchronization signals and PBCH are transmitted together, they may be referred to as an SS/PBCH. For convenience of description, the following description assumes that an SSB includes a PSS, SSS, and PBCH.

The PSS and SSS included in the SSB are provided to synchronize a downlink (DL) for MSs within the communication area of the BS, and since they provide the PCI, their values may differ from those of adjacent BSs. Since the PCI is information for identifying a cell, all TRPs 311 and 312 included within the cell 310 need to provide the same PCI to the MS 301. In other words, each of the first TRP 311 and the second TRP 312 may broadcast the same PSS and SSS to the MS 301 located within the cell 310.

In the exemplary embodiment of FIG. 3A, only the case where two TRPs 311 and 312 exist within the single cell 310 is illustrated, but the present disclosure is not limited thereto. In other words, a case where only one TRP exists within the cell 310 and/or a case where three or more TRPs exist may also be applied to exemplary embodiments of the present disclosure.

FIG. 3A illustrates an exemplary embodiment of the case where multiple TRPs (mTRPs) are included in a single cell. In the following description, a case where two or more TRPs are included in a single cell may be referred to as an ‘intra-cell mTRP environment’ or an ‘intra-cell mTRP scenario’.

FIG. 3B is a conceptual diagram describing signal transmission between inter-cell multiple TRPs and an MS.

Referring to FIG. 3B, an exemplary embodiment of a case is illustrated where each of different cells 320 and 330 communicates with an MS 301 through one TRP 321 or 331. The second cell 320 may be a communication area controlled by TRP(s) controlled by a second BS (not shown in FIG. 3B), and the third cell 330 may be a communication area controlled by TRP(s) controlled by a third BS (not shown in FIG. 3B). In the case of FIG. 3B, only one TRP is illustrated in one cell for convenience of description, but the present disclosure is not limited thereto. In other words, the second cell 320, which is a communication area of the second BS, may be determined by a signal transmission range of two or more TRPs, and the third cell 330, which is a communication area of the third BS, may also be determined by a signal transmission range of two or more TRPs.

As described above, since a PCI determined by a PSS and SSS is used to distinguish each cell, when a PCI broadcasted by the third TRP 321 of the second cell 320 is referred to as a second PCI and a PCI broadcasted by the fourth TRP 331 of the third cell 330 is referred to as a third PCI, the second PCI and the third PCI may have different values.

In the case of FIG. 3B, the MS 301 may receive an SSB from the third TRP 321 and may receive an SSB from the fourth TRP 331. The MS 301 may obtain the second PCI based on the SSB received from the third TRP 321 and may obtain the fourth PCI based on the SSB received from the fourth TRP 331. The MS 301 may compare the obtained second PCI with the obtained third PCI to determine whether they have the same value or different values. In the case of FIG. 3B, since the second cell 320 of the third TRP 321 and the third cell 330 of the fourth TRP 331 are different from each other, the second PCI and the third PCI may be different values. Therefore, the MS 301 may confirm that the third TRP 321 and the fourth TRP 331 are TRPs belonging to different cells.

The MS 301 that wishes to perform communication may select either the third TRP 321 or the fourth TRP 331 and perform communication through an initial access procedure with the selected TRP. If the MS 301 communicates with the second cell 320, the third cell 330 may be an adjacent cell of the second cell 320. Conversely, if the MS 301 communicates with the third cell 330, the second cell 320 may be an adjacent cell of the third cell 330. When the MS 301 communicates with a specific cell as described above, the cell communicating with the MS 301 may be referred to as a serving cell.

In the example of FIG. 3B, when the MS 301 communicates with the second cell 320, the MS 301 may receive signals from the third TRP 321, and the second cell 320 may be a serving cell of the MS 301. In addition, the MS 301 may obtain a PCI from the fourth TRP 331 of the third cell 330 with a different PCI value. In other words, the MS 301 may be in a state where it can receive PCIs from both the serving cell and a non-serving cell. Such an environment or scenario will be referred to as an ‘inter-cell mTRP environment’ or an ‘inter-cell mTRP scenario’ in the present disclosure described below.

In FIG. 3B, when describing the inter-cell mTRP environment or inter-cell mTRP scenario, the case where there is one adjacent cell is illustrated, but this is merely for convenience of description, and there may be two or more adjacent cells. In addition, in FIG. 3B, when describing the inter-cell mTRP environment or inter-cell mTRP scenario, the case is assumed where a PCI is received from one TRP other than the serving cell of the MS 301, but it is not limited thereto. In other words, the MS 301 may receive two or more PCIs from two or more TRPs other than a TRP of the serving cell. The PCIs received from the two or more TRPs may have the same PCI value or may have different PCI values. If the PCIs received from the two or more TRPs have the same value, it may correspond to the case where the PCIs are received from different TRPs included in the same third cell 330. If the PCIs received from the two or more TRPs have different values, it may correspond to the case where the PCIs are received from the fourth TRP 331 included in the third cell 330 and a TRP included in a cell other than the second cell 320 and the third cell 330 (not shown in FIG. 3B).

In the intra-cell mTRP environment or intra-cell mTRP scenario illustrated in FIG. 3A, a case is exemplified where a distance between the MS 301 and the first TRP 311 and a distance between the MS 301 and the second TRP 312 have the same or similar distance values. In addition, in the inter-cell mTRP environment or inter-cell mTRP scenario illustrated in FIG. 3B, a case is exemplified where a distance between the MS 301 and the third TRP 321 and a distance between the MS 301 and the fourth TRP 331 have the same or similar distance values. However, in an actual communication environment, the distances between the MS 301 and two different TRPs may have a significantly large difference.

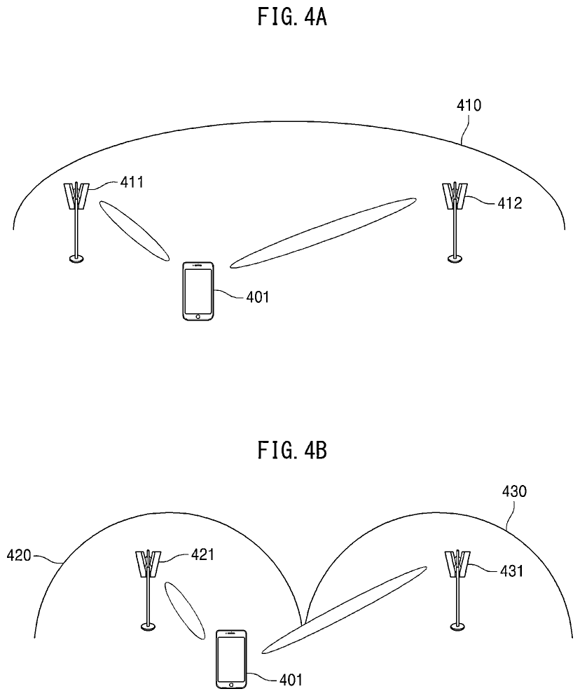

FIG. 4A is a conceptual diagram describing intra-cell mTRP-based uplink and downlink transmission.

Referring to FIG. 4A, two different TRPs 411 and 412 and one MS 401 are exemplified within a single cell 410. In FIG. 4A, only two TRPs 411 and 412 are exemplified within the cell 410 for convenience of description, without being limited thereto. In other words, three or more TRPs controlled by one BS (not shown in FIG. 4A) may be included within the cell 410.

As described above, since the first TRP 411 and the second TRP 412 are included within the cell 410, they may broadcast the same PCI. Therefore, the MS 401 may receive the same PCI from the first TRP 411 and the second TRP 412. The MS 401 may communicate with one (i.e. single TRP (sTRP)) of the first TRP 411 or the second TRP 412, or may communicate with both the first TRP 411 and the second TRP 412.

When the MS 401 communicates with the first TRP 411, the MS 401 may receive signals (or data) through a downlink channel from the first TRP 411, and may transmit signals (or data) through an uplink channel to the first TRP 411. In addition, when the MS 401 communicates with the second TRP 412, the MS 401 may receive signals (or data) through a downlink channel from the second TRP 412, and may transmit signals (or data) through an uplink channel to the second TRP 412.

When the MS 401 communicates with both the first TRP 411 and the second TRP 412, the MS 401 may receive signals (or data) through a downlink channel from the first TRP 411 and a downlink channel from the second TRP 412. In addition, when the MS 401 communicates with both the first TRP 411 and the second TRP 412, the MS 401 may transmit signals (or data) through an uplink channel to the first TRP 411 and an uplink channel to the second TRP 412. In other words, the MS 401 may communicate with an sTRP (e.g. the first TRP 411 or the second TRP 412) or may communicate with an mTRP (e.g. the first TRP 411 and the second TRP 412).

Hereinafter, as illustrated in FIG. 4A, the case in which the MS 401 communicates with the first TRP 411 and the second TRP 412 will be described. The exemplary embodiment of FIG. 4A corresponds to a case in which the first TRP 411 and the second TRP 412 are TRPs included in the same cell 410. Therefore, the MS 401 may be in a state of communicating with two different TRPs 411 and 412 included in one serving cell. When the first TRP 411 and the second TRP 412 transmit signals (or data) to the MS 401 through downlink channels, the downlink channel of the first TRP 411 and the downlink channel of the second TRP 412 may have the same configuration and share the same resources. In addition, the MS 401 may transmit the same data or different data through the uplink channel to the first TRP 411 and the uplink channel to the second TRP 412.

Meanwhile, it is currently stipulated that a BS has a single time adjustment value to be applied to the MS 401. In the present disclosure, a time adjustment value may be referred to as a timing advance (TA) value, timing adjustment (or time adjustment) value, and/or timing alignment (or time alignment) value. Accordingly, the BS may allocate a single time adjustment value for the MS 401 to the TRPs 411 and 412 that communicate with the MS 401 among TRPs included in the same cell. Accordingly, the first TRP 411 and the second TRP 412 within the cell 410 may share the same TA value for the MS 401. In addition, the MS 401 may receive the TA value set by the BS through the first TRP 411 and/or the second TRP 412. Therefore, the MS 401 communicating within the serving cell 410 may perform communication with multiple TRPs using one TA value regardless of the number of TRPs communicating with the MS 401 within the serving cell 410.

A problem occurring when using a single TA value will be described with reference to FIG. 4A.

According to the example of FIG. 4A, the case where a distance between the first TRP 411 and the MS 401 is shorter than a distance between the second TRP 412 and the MS 401 is exemplified. In other words, if the distance between the first TRP 411 and the MS 401 is d1 and the distance between the second TRP 412 and the MS 401 is d2, the relationship of ‘d1<d2’ may be established. When d1 and d2 are different from each other as described above, a propagation delay between the first TRP 411 and the MS 401 and a propagation delay between the second TRP 412 and the MS 401 may have different values. It may be assumed that the propagation delay between the first TRP 411 and the MS 401 is τ1, the propagation delay between the second TRP 412 and the MS 401 is 12, and signals in the wireless communication system are transmitted and received based on an orthogonal frequency-division multiplexing (OFDM) scheme. An OFDM symbol may have a cyclic prefix (CP) of a preset length.

The length of CP may be determined based on a distance and/or a propagation delay between a TRP and the MS. In other words, in the case of FIG. 4A, the length of CP may be determined based on τ1 (or d1) or based on τ2 (or d2). The CP may be inserted into a starting part of an OFDM symbol by copying from an ending part of the OFDM symbol, and may be transmitted for a certain period of time during transmission of the OFDM symbol. It is assumed that a time duration during which the CP is transmitted is T_{CP}. In addition, it is assumed that a TA value based on the distance d1 between the first TRP 411 and the MS 401 is applied equally to the first TRP 411 and the second TRP 412.

In the above-assumed situation, that is, in the case where the BS manages only a single TA value for the MS 401 in the intra-cell mTRP scenario, the following problem may occur in the case of FIG. 4A.

The first TRP 411 may transmit an OFDM symbol to the MS 401 through a first downlink channel, and the second TRP 412 may transmit an OFDM symbol to the MS 401 through a second downlink channel. Then, the MS 401 may receive the OFDM symbol from the first TRP 411 through the first downlink channel and also receive the OFDM symbol from the second TRP 412 through the second downlink channel. In this case, if a difference between τ1 and τ2 is greater than αT_{CP} which is proportional to T_{CP}, the MS 401 may receive OFDM symbols affected by interference (i.e. inter-symbol interference (ISI)) between the OFDM symbol received through the first downlink channel and the OFDM symbol received through the second downlink channel. In addition, the first downlink channel and the second downlink channel may experience inter-carrier interference (ICI). In addition, when uplink transmission is performed from the MS 401 to the first TRP 411 and the second TRP 412, signals received at the second TRP 412 may experience ISI and ICI.

FIG. 4B is a conceptual diagram describing inter-cell mTRP-based uplink and downlink transmission.

The exemplary embodiment of FIG. 4B exemplifies a case where a second cell 420 includes a third TRP 421 and a third cell 430 includes a fourth TRP 431. In FIG. 4B, only one TRP is exemplified in each of the cells 420 and 430, but this is merely for convenience of description, and two or more TRPs may be included in each of the cells 420 and 430.

The third TRP 421 included in the second cell 420 may broadcast a second PCI, and the fourth TRP 431 included in the third cell 430 may broadcast a third PCI. Accordingly, the MS 401 may receive the second PCI from the third TRP 421 included in the second cell 420 and may receive the third PCI from the fourth TRP 431 included in the third cell 430. The MS 401 may confirm that the third TRP 421 and the fourth TRP 431 belong to different cells based on the second PCI received from the third TRP 421 and the third PCI received from the fourth TRP 431.

The MS 401 may communicate with one (i.e. sTRP) of the third TRP 421 and the fourth TRP 431, or may communicate with both the third TRP 421 and the fourth TRP 431. In the following, in order to describe the inter-cell mTRP scenario, it is assumed that the MS 401 communicates with both the third TRP 421 and the fourth TRP 431.

As illustrated in FIG. 4B, each of the TRPs 421 and 431 included in different cells 420 and 430 may perform uplink and downlink transmission with the MS 401. For example, the third TRP 421 may perform downlink transmission to the MS 401, and the fourth TRP 431 may perform downlink transmission to the MS 401. The MS 401 may perform uplink transmission to the third TRP 421, and uplink transmission to the fourth TRP 431.

In the example of FIG. 4B, a serving cell for the MS 401 may be the second cell 420. In this case, the third TRP 421 of the serving cell 420 may transmit the second PCI, and the fourth TRP 431 of the non-serving cell 430 may transmit the third PCI.

According to the current 3GPP standards, a BS of the second cell 420 is stipulated to have a single time adjustment value for the MS 401. In addition, a BS of the non-serving cell 430 is not stipulated to have a time adjustment value for the MS 401. In terms of implementation, the BS of the non-serving cell 430 may use the time adjustment value set by the serving cell (i.e. the second cell 420) for the MS 401 as the time adjustment value for the MS 401.

However, when applying the TA value for the third TRP 421 of the serving cell 420 to the fourth TRP 431 belonging to the non-serving cell 430 of the MS 401, the problem described in FIG. 4A may arise.

A distance between the third TRP 421 of the serving cell 420 and the MS 401 may be shorter than a distance between the fourth TRP 432 of the non-serving cell 430 and the MS 401. In other words, if the distance between the third TRP 421 and the MS 401 is d3 and the distance between the fourth TRP 431 and the MS 401 is d4, the relationship of ‘d3<d4’ may be established. When d3 and d4 are different from each other as described above, a propagation delay between the third TRP 421 and the MS 401 and a propagation delay between the fourth TRP 431 and the MS 401 may have different values. It may be assumed that the propagation delay between the third TRP 421 and the MS 401 is 13, the propagation delay between the fourth TRP 431 and the MS 401 is 14, and signals are transmitted and received in the wireless communication system in form of OFDM symbols. An OFDM symbol may have a CP of a preset length.

As described above, when a difference between τ3 and τ4 is greater than αT_{CP} which is proportional to T_{CP}, when performing downlink transmission from the fourth TRP 431 to the MS 401, signals received at the terminal may experience ISI and ICI. When performing uplink transmission from the MS 401 to the third TRP 421 and the fourth TRP 431, signals received at the fourth TRP 431 may experience ISI and ICI.

In the present disclosure described below, methods for setting time adjustment values between the MS and TRPs in an mTRP environment will be described.

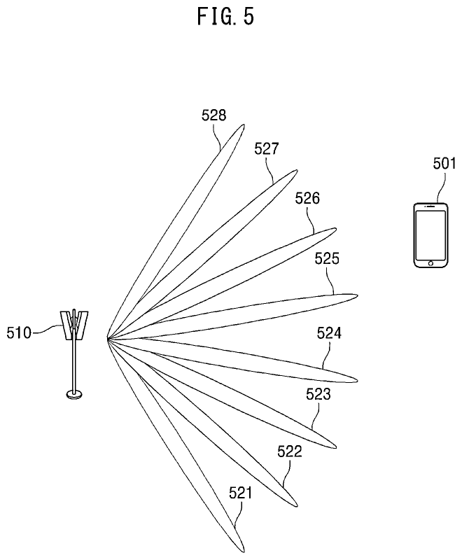

FIG. 5 is a conceptual diagram describing a case where a TRP transmits SSBs in a beam sweeping scheme.

Referring to FIG. 5, a TRP 510 may form multiple beams and transmit SSBs through the respective beams. In the example of FIG. 5, the TRP 510 may transmit beams 521, 522, 523, 524, 525, 526, 527, and 528 in eight directions. However, the number of beams that the TRP 510 can transmit is not limited to eight. The TRP 510 may perform beam sweeping using multiple beams in each SSB transmission period. In this case, SSB indices of SSBs transmitted through the respective swept beams may have different values.

According to the 5G NR standards, the TRP 510 is stipulated to sequentially increase the SSB indices from the first transmitted beam to the last transmitted beam. For example, the TRP 510 may transmit an SSB having an SSB index #0 through the first beam 521, an SSB having an SSB index #1 through the second beam 522, an SSB having an SSB index #2 through the third beam 523, an SSB having an SSB index #3 through the fourth beam 524, an SSB having an SSB index #4 through the fifth beam 525, an SSB having an SSB index #5 through the sixth beam 526, an SSB having an SSB index #6 through the seventh beam 527, and an SSB having an SSB index #7 through the eighth beam 528.

The MS 501 may receive SSBs through the multiple beams transmitted by the TRP 510. The MS 501 may measure reception signal strengths or reception signal qualities of the SSBs received through the multiple beams. In the present disclosure, it is assumed that the MS 501 measures reception signal strengths. The MS 501 may measure reception signal strengths of the received SSBs and sort the SSBs in descending order based on their reception signal strengths, for example, from an SSB with the highest reception signal strength to an SSB with the lowest reception signal strength. Then, the MS 501 may select the SSB with the highest reception signal strength. The MS 501 may perform downlink synchronization based on the selected SSB.

In the example of FIG. 5, the case is exemplified where one TRP transmits SSBs through the respective beams by beam sweeping. However, in an actual communication environment, the MS 501 may receive different SSBs from multiple TRPs. When the MS 501 receives different SSBs from multiple TRPs, the MS 501 may obtain a PCI through a PSS and SSS included in each SSB. Through this, the MS 501 may identify whether the received SSBs are SSBs received from TRPs belonging to the same cell or SSBs received from TRPs belonging to different cells. However, when two or more TRPs exist within the same cell, the MS 501 may not be able to identify whether the received SSBs are SSBs received from different TRPs or SSBs received from the same TRP.

Therefore, the present disclosure proposes methods for predetermining SSB indices that can be transmitted by the respective TRPs and grouping TRPs that can transmit the same SSB index in the mTRP environment.

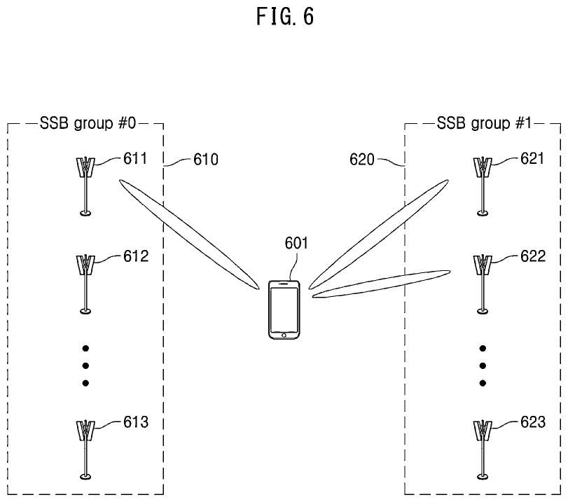

FIG. 6 is a conceptual diagram describing a case where TRPs are grouped into SSB groups in an mTRP environment.

Referring to FIG. 6, multiple TRPs 611, 612, . . . , and 613 included in an SSB group #0 610 and multiple TRPs 621, 622, . . . , and 623 included in an SSB group #1 620 are exemplified. In FIG. 6, only two groups, the SSB group #0 610 and SSB group #1 620, are exemplified, but there may be three or more SSB groups.

According to an exemplary embodiment of the present disclosure, it may be assumed that the TRPs 611, 612, . . . , and 613 included in the SSB group #0 610 transmit SSBs having even SSB indices including an SSB index 0, and the TRPs 621, 622, . . . , and 623 included in the SSB group #1 620 transmit SSBs having odd SSB indices.

If the SSBs are grouped into three groups, TRPs included in a first SSB group may transmit SSBs having SSB indices with a value of 3n, TRPs included in a second SSB group may transmit SSBs having SSB indices with a value of 3n+1, and TRPs included in a third SSB group may transmit SSBs having SSB indices with a value of 3n+2. Here, n may be an integer greater than or equal to 0.

In FIG. 6, a case is illustrated where the MS 601 is able to receive or communicate signals from the first TRP 611 of the SSB group #0, the first TRP 621 of the SSB group #1, and the second TRP 622 of the SSB group #1. In this case, when the first TRP 611 of the SSB group #0 has a TA offset of 0, the first TRP 621 of the SSB group #1 and the second TRP 622 of the SSB group #1 may have a TA offset of 1.

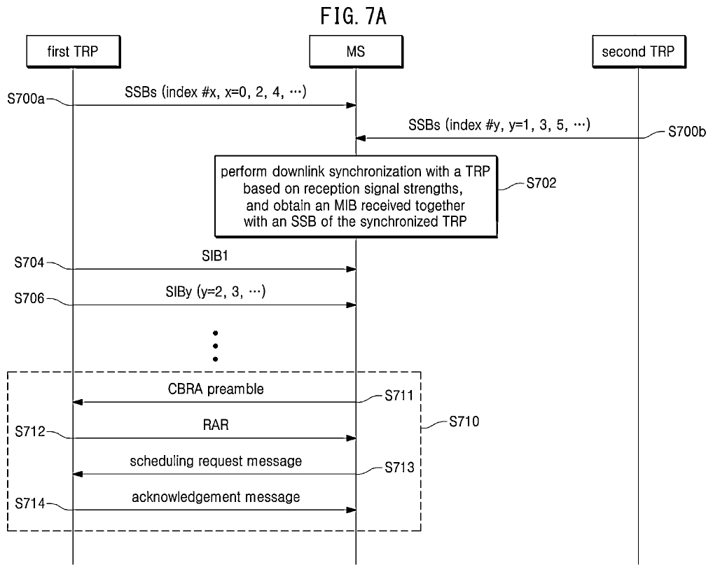

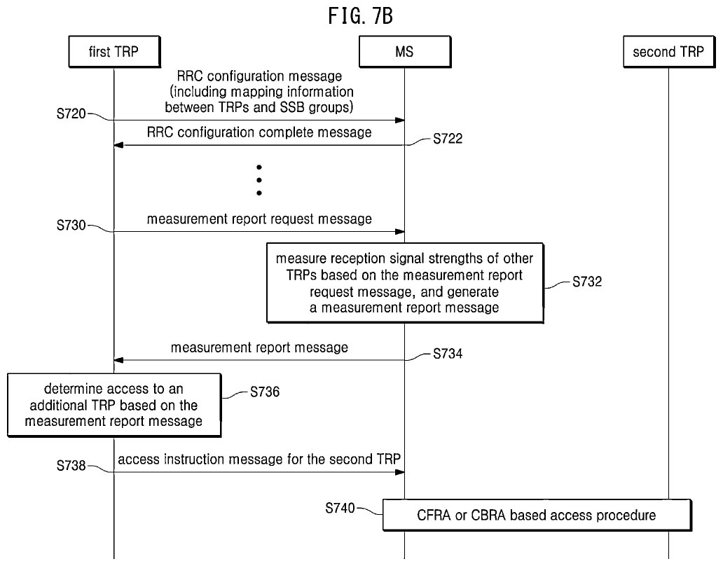

FIG. 7A is a sequence chart describing a case where an MS accesses a first TRP in an mTRP environment.

In referring to FIG. 7A, it is assumed that a first TRP is a TRP included in the SSB group #0 described in FIG. 6, and a second TRP is a TRP included in the SSB group #1 described in FIG. 6. It is also assumed that the MS performs an initial access procedure while not connected to any TRP. In addition, a procedure described in FIG. 7A may be a procedure where the MS initially accesses either the first TRP or the second TRP.

In step S700a, the first TRP may transmit SSBs by performing beam sweeping using multiple beams. In this case, since the first TRP is a TRP included in the SSB group #0 as described above, the SSBs transmitted through the respective multiple beams may have an SSB index #0, SSB index #2, SSB index #4, . . . , and the like. In addition, as described above, each SSB may include a PSS, SSS, and PBCH. In step S700a, the MS may receive SSBs transmitted by the first TRP through multiple beams. The MS may measure reception signal strengths of the received SSBs. In this case, the MS may receive the SSBs through reception beam sweeping.

In step S700b, the second TRP may transmit SSBs by performing beam sweeping using multiple beams. In this case, since the second TRP is a TRP included in the SSB group #1 as described above, the SSBs transmitted through the respective multiple beams may have an SSB index #1, SSB index #3, SSB index #5, . . . , and the like. In addition, as described above, each SSB may include a PSS, SSS, and PBCH. In step S700b, the MS may receive SSBs transmitted by the second TRP through multiple beams. The MS may measure reception signal strengths of the received SSBs. Similarly to step S700a, when the MS receives SSBs from the second TRP, the MS may receive the SSBs through reception beam sweeping.

As described in steps S700a and S700b, SSB transmission by each of the first TRP and the second TRP may be performed periodically.

In step S702, the MS may compare the reception signal strength of the SSB received from the first TRP with the reception signal strength of the SSB received from the second TRP. In the example of FIG. 7A, it is assumed that the reception signal strength of the SSB received from the first TRP is greater than the reception signal strength of the SSB received from the second TRP. Therefore, the MS may perform downlink synchronization with the first TRP based on the SSB received from the first TRP. In addition, the terminal may obtain a master information block (MIB) included in a PBCH received as part of the SSB from the first TRP. If the MS fails to receive, demodulate, and decode the PBCH during steps S700a and S700b, the MS may obtain the MIB by receiving an SSB from the first TRP in the next period.

For the MS that has not acquired initial synchronization, the MIB may be system information that is first received from the network. The MIB may include information on a resource (e.g. time and frequency resource) from which a system information block 1 (SIB1) can be obtained. Therefore, the MS may obtain information on the resource for obtaining the SIB1 from the MIB in step S702.

In step S704, the first TRP may transmit the SIB1 through a physical downlink shared channel (PDSCH). The SIB1 may be repeatedly transmitted at a constant periodicity (e.g. 160 ms). Therefore, the SIB1 transmitted in step S704 may be an SIB1 transmitted by the first TRP at a preset periodicity. In step S704, the MS may receive the SIB1 from the first TRP. Then, the MS may demodulate and decode the received SIB1 to obtain information included in the SIB1. The SIB1 may include availability and scheduling information of other SIBs. Therefore, the MS may obtain scheduling information of other SIBs from the SIB1. The scheduling information of other SIBs may include information such as periodicities at which other SIBs are transmitted, SI-window size, and the like.

In step S706, the first TRP may transmit an SIBy based on a transmission periodicity of the SIBy other than the SIB1. Here, y may be a natural number greater than or equal to 2. In other words, in step S706, the first TRP may transmit SIBs such as SIB2, SIB3, . . . and the like according to the transmission periodicity of each SIB. Therefore, in step S706, the MS may receive the SIBy based on the SIB scheduling information obtained from the SIB1. According to the 5G NR standards, SIBs other than the SIB1 may be classified into SIBs that are transmitted periodically and SIBs that are transmitted in response to a request of the MS. The SIBy mentioned in the present disclosure may be assumed to be the SIB transmitted periodically.

The SIBy (y is a natural number greater than or equal to 2) according to the present disclosure may include at least one of mapping relationship information between TRPs and SSB groups or information on a TA offset for each SSB group. The mapping relationship information between TRPs and SSB groups may include information on mapping between SSB groups and TRPs (i.e. the first TRP and other adjacent TRPs). In other words, the mapping relationship information may include the number of SSB groups and information on TRPs included in each of the SSB groups. Therefore, the first TRP may also be included in one of the SSB groups. However, if the SIBy provides information on mapping between all SSB groups and all TRPs as described above, there may be a burden that the size of SIBy needs to become very large. As an exemplary embodiment for reducing the size of the system information, the SIBy may include only the number of SSB groups and information on the SSB group to which the first TRP belongs. As another exemplary embodiment for reducing the size of the system information, the SIBy may include only the number of SSB groups, information on the SSB group to which the first TRP belongs, and information on an SSB index used by the SSB group to which the first TRP belongs.

Based on the mapping relationship information between TRPs and SSB groups, the MS may identify the SSB group of the first TRP. If there are no size constraints on the SIBy, the mapping relationship information between TRPs and SSB groups may include information on TRPs included in the SSB group #0 and TRPs included in the SSB group #1 as exemplified in FIG. 6, in addition to the information on the SSB group of the first TRP.

Through the procedure described above, the MS may perform downlink synchronization with the first TRP.

Thereafter, the MS may perform step S710 if uplink transmission is required. Step S710 may be a procedure for performing uplink synchronization using a contention-based random access (CBRA) procedure. The CBRA procedure may be composed of four steps.

In step S711, the MS may randomly select one of the entire preambles provided by the first TRP and transmit the selected preamble to the first TRP through a physical random access channel (PRACH). A direction of a beam that the MS transmits to the first TRP may be configured to have reciprocity with a direction of a beam through which a signal (e.g. SSB1) was received in downlink. A transmission resource of the preamble that the MS transmits to the first TRP may be determined based on a random access channel (RACH) occasion (RO) acquired in advance. In step S711, the first TRP may receive the preamble from the MS. Then, the first TRP may estimate a propagation delay between the MS and the first TRP based on the received preamble. Based on the estimated propagation delay, the first TRP may determine a time adjustment value (e.g. timing advance, time adjustment, or time alignment value) between the MS and the first TRP. In the following description, the time adjustment value will be referred to as a ‘TA value’. The TA value may refer to at least one of a timing advance, time adjustment, or time alignment value. As described above, since the preamble transmitted by the MS is randomly selected and transmitted by the MS, the first TRP may not be able to specify which MS transmitted the preamble even if the preamble is detected from the PRACH.

Since step S710 corresponds to the CBRA-based procedure, multiple MSs may simultaneously transmit preambles using the same RO in step S711. Therefore, even if the preamble is received on the PRACH in step S711, the first TRP may not be able to determine whether the received preamble is transmitted by one MS or two or more MSs.

In step S712, the first TRP may determine whether a preamble exist in a signal received through the PRACH. If a preamble exists, the first TRP may consider that at least one MS has transmitted the preamble. In step S712, the first TRP may transmit a random access response (RAR) message to the MS through a PDSCH, based on an index of the detected preamble. The RAR transmitted by the first TRP to the MS may include at least one of an index of the detected preamble, a TA value, uplink grant information, a temporary cell-radio network temporary identifier (C-RNTI) value, or a TA group identifier (ID). In addition to the information described above, the RAR may include additional information as needed. In step S712, the MS may receive the RAR through a direct link from the first TRP.

Here, the TA group ID may be composed of one bit or may be composed of two or more bits. If the TA group ID is composed of one bit, it may correspond to a case where there are two TA groups as exemplified in FIG. 6. If three or four TA groups are configured, the TA group ID may be composed of two bits. If five or more TA groups are configured, the TA group ID may be composed of as many bits as the number of bits required for expressing the TA groups.

In step S713, the MS may transmit a connection request (or scheduling request (SR)) message to the first TRP through a PUSCH based on the information included in the received RAR (e.g. uplink radio resource indicated by the uplink grant information). The connection request message may be transmitted using the uplink radio resource indicated by the uplink grant information included in the RAR. The connection request message may include a unique identifier (MS ID) of the MS. The MS ID included in the connection request message may be transmitted in a form scrambled using the temporary C-RNTI included in the RAR. In step S713, the first TRP may receive the connection request message from the MS.

On the other hand, as described in step S711 above, one or more MSs may have transmitted the same preamble. In other words, multiple MSs may transmit the same preamble in the same RO. All MSs that transmitted the same preamble may transmit the connection request messages to the first TRP through the same radio resource based on the RAR received in step S712. A collision may occur due to the connection request messages transmitted by multiple MSs. Since different MSs that transmitted the same preamble all recognize that the PUSCH resource is allocated to them, a resource collision may occur due to the different MSs transmitting PUSCHs to the first TRP using the same resource.

As part of a procedure to check whether the connection request message transmitted by the MS in step S713 has encountered a collision or has been successfully decoded in the first TRP, the MS may start a contention resolution timer when transmitting the message in step S713 (not shown in FIG. 7A).

If the connection request message received through the PUSCH is normally received and successfully decoded, the first TRP may perform step S714. The first TRP may decode the message received in step S713, and if successfully decoded, may transmit an acknowledgment message for the successfully decoded message to the MS through a PDSCH in step S714.

The MS that receives the acknowledgement message in step S714 before the contention resolution timer started in step S713 expires may determine that the random access is successful and may use the temporary C-RNTI as its own C-RNTI to continue using it in a system connected state. On the other hand, the MS that does not receive any acknowledgement message until the contention resolution timer expires may determine that the message transmitted in step S713 failed to be decoded in the first TRP due to a collision or other reasons. The MS that does not receive an acknowledgement message from the first TRP until the contention resolution timer expires may perform a backoff procedure and reattempt the random access procedure (not shown).

The first TRP may define a maximum number of random access attempts to prevent random access channel congestion. The maximum number of random access attempts may be set directly by the first TRP or may be set by a BS connected to the first TRP. Information on the maximum number of random access attempts defined as described above may be transmitted to the MS through higher layer signaling. The MS may receive (or obtain) information on the maximum number of random access attempts from the first TRP through higher layer signaling. If the MS determines that the message transmitted in step S713 failed to be decoded in the first TRP due to a collision or other reasons, the MS may perform a backoff procedure and reattempt the random access procedure, within the maximum number of attempts received through higher layer signaling.

If the random access procedure is attempted for the maximum number of attempts but the random access is not successful, the MS may abandon the random access and perform downlink synchronization again. In other words, if the random access procedure fails for the maximum number of attempts, the MS may start again from step S701a.

FIG. 7B is a sequence chart describing a case where the MS accesses the second TRP while connected to the first TRP in an mTRP environment.

The operation described in FIG. 7B may be a continuous operation of the operation described in FIG. 7A. In other words, it may be a procedure performed after the MS accesses a specific TRP.

In step S720, the first TRP may transmit a higher layer signaling (e.g. RRC configuration (or, setup) message or RRC reconfiguration message) to the MS. Since the following description is made assuming a case where the MS is performing the initial access procedure, it is assumed that an RRC configuration message is used. However, it should be noted that an RRC reconfiguration message may be used. In addition, the RRC configuration message may be controlled by the BS to be transmitted, which is an upper node to which the first TRP is connected. In step S720, the MS may receive the RRC configuration message from the first TRP. The RRC configuration message may include the mapping relationship information between TRPs and SSB groups, and a TA offset value for each SSB group. The mapping relationship between TRPs and SSB groups may include information on SSB groups for not only the first TRP but also other TRPs, for example, information on SSB groups for TRPs adjacent to the first TRP. In the case of the RRC configuration message, since there is less restriction on the amount of information mentioned in the SIBy above, additional information may be provided in addition to the information provided in the SIBy. Therefore, the remaining information not provided in the SIBy may be provided through the RRC configuration message.

An example of the mapping relationship information between TRPs and SSB groups may be described as follows. The mapping relationship information between TRPs and SSB groups included in the RRC message may define information on the number of SSB index groups and SSB indices used in the respective SSB index groups, and may include information on an SSB index group used by TRP(s). For example, it may be assumed that SSB groups are divided into a first SSB index group and a second SSB index group. Then, the number of SSB index groups may be two. In addition, the first SSB index group may be defined to use even SSB indices including an SSB index 0, and the second SSB index group may be defined to use odd SSB indices. Under the above-described definition, the mapping relationship information between TRPs and SSB groups included in the RRC message may further include information indicating an SSB index group of the first TRP. Further, in addition to the first TRP, it may further include information on SSB index group(s) of other TRPs, for example, a second TRP, a third TRP, and the like adjacent to the first TRP.

The above example assumes two SSB index groups, but may be applied equally to cases where there are three or more SSB index groups.

In step S722, the MS may transmit an RRC configuration complete message to the first TRP in response to the RRC configuration message received in step S720. In step S722, the first TRP may receive the RRC configuration complete message from the target MS to which the RRC configuration message was transmitted. Through the procedure of steps S720 and S722, the MS may complete connection setup through a direct link with the first TRP. After the procedure of steps S720 and S722, the MS may perform communication with the first TRP.

In step S730, the first TRP may transmit a measurement report request message to the MS. Therefore, in step S730, the MS may receive the measurement report request message from the first TRP. As the measurement report request message, a higher layer signaling message may be used when requesting static periodic measurement reporting, a medium access control (MAC)-control element (CE) may be used when requesting semi-static periodic measurement reporting, and downlink control information (DCI) may be when requesting aperiodic measurement reporting. In addition, the measurement report request message may request measurement report(s) on signals received from the first TRP and/or adjacent TRPs. In other words, the measurement report request message may instruct measurement on strengths of signals received from the first TRP and/or other adjacent TRPs. As another example, the measurement report request message may instruct measurement on qualities of signals received from the first TRP and/or other adjacent TRPs. In the following description, for convenience of description, it is assumed that measurement on signal strengths is instructed.

The measurement report request message may indicate information to be included in measurement report messages. For example, the measurement report request message may include information on the number of measured signal strengths to be included in the measurement report message. The number of measured signal strengths to be included in the measurement report message may be one or more. Where the number of measured signal strengths to be included in the measurement report message is one, the measurement report message may include only a measurement value for the first TRP. As another example, when the number of measured signal strengths to be included in the measurement report message is one, the measurement report message may include information on the highest signal strength among signal strengths of signals received from other TRPs excluding the first TRP.

When the number of measured signal strengths to be included in the measurement report message is two or more, the measurement report message may include measured signal strengths in descending order, starting with the highest signal strength.

As another example, the measurement report request message may instruct to report all measured signal strengths.

The measurement report request message may instruct to include cell and/or TRP related information in the measurement report message. The cell related information may be, for example, PCI information. The TRP related information may be, for example, information on an SSB group.

The measurement report request message may instruct to include time difference information in the measurement report message. The time difference information may be information on a time difference between a synchronization signal received from the first TRP to which the MS is currently connected and a synchronization signal received from another TRP included in the measurement report message. In this case, if two or more measured signal strengths are requested, the measurement report message may include information on cells and/or TRPs corresponding to the respective measured signal strengths.

In step S732, the MS may measure a signal strength of a signal received from the first TRP based on the measurement report request message received from the first TRP, and store it in a memory of the MS (e.g. the memory 220 or the storage device 260 of FIG. 2). In addition, the MS may measure signal strengths of signals received from other TRPs other than the first TRP and store them in the memory. In this case, target signals on which the MS performs measurement may be SSBs received from the first TRP and SSBs received from other TRPs. When measuring the SSBs as described above, the MS may identify SSB groups of the respective TRPs based on the mapping relationship information between TRPs and SSB groups included in the RRC configuration message received in step S720.

In step S732, the MS may generate the measurement report message based on the measurement report request message and the measured signal strengths. The measurement report message may include the information requested by the measurement report request message. Therefore, the measurement report message may include at least one of the number of measured signal strengths, signal strength values corresponding to the respective measured signal strengths, information on a PCI and/or TRP corresponding to each signal strength, or information on a synchronization time difference value corresponding to each signal strength.

In step S734, the MS may transmit the measurement report message generated in step S732 to the first TRP. Therefore, in step S734, the first TRP may receive the measurement report message from the MS.

In step S736, the first TRP may determine whether an additional access to (or connection with) another TRP is required for the MS based on the measurement report message. In FIG. 7B, it is assumed that the first TRP determines whether an additional access to another TRP is required for the MS. Alternatively, step S736 may be determined by the BS connected to the first TRP. In FIG. 7b, a case is assumed where a second TRP is determined to be added.

In step S738, the first TRP may transmit an access instruction message for the second TRP to the MS. Therefore, in step S738, the MS may receive the access instruction message for the second TRP from the first TRP. For example, a PDCCH order may be used as the access instruction message for the second TRP. The PDCCH order may be a control message used for the network to instruct the MS to perform random access, and may be transmitted through DCI. Hereinafter, description will be made assuming that the PDCCH order is used as the access instruction message for the second TRP.

The PDCCH order may indicate a target to which the MS is to perform access. In other words, the first TRP may instruct the MS to access the second TRP through the PDCCH order. The PDCCH order may indicate location information of a preamble transmission resource, for example, a time and frequency resource. In other words, a preamble to be transmitted by the MS to the second TRP may be scheduled by the first TRP.

In addition, the PDCCH order may indicate either contention-based random access (CBRA) or contention-free random access (CFRA). If the CFRA scheme is used, the PDCCH order may indicate a preamble. In other words, the PDCCH order may indicate a preamble that the MS will transmit to the second TRP.

In the example of FIG. 7B, it is assumed that the CFRA scheme is used. When the CBRA scheme is used, a procedure that is the same as step S710 described in FIG. 7A may be performed.

In step S740, the MS may perform a random access procedure with the second TRP based on the CFRA scheme. The random access procedure based on the CFRA scheme may be performed as a two-step procedure.

In the first step, the MS may transmit a preamble to the second TRP. In this case, the preamble may be the preamble that the first TRP has indicated to the MS. In other words, the access instruction message for the second TRP (e.g. PDCCH order) may indicate the preamble to be used when accessing the second TRP. Accordingly, the MS may transmit the preamble indicated by the access instruction message to the second TRP in the first step. When transmitting the preamble to the second TRP, the MS may transmit the preamble in a random access occasion (RO). The MS may transmit the preamble in a direction corresponding to a direction of a beam from which an SSB received from the second TRP was measured. In addition, as described in FIGS. 4A and 4B, the distance between the first TRP and the MS and the distance between the second TRP and the MS may be different from each other. Therefore, the MS may transmit the preamble to the second TRP by adjusting a transmission time of the preamble by a TA offset included in the access instruction message.

When transmitting the preamble in the first step, the MS may know in advance whether the target TRP to which the MS performs random access is the second TRP or the third TRP from an SSB index and PCI included in the PDCCH order received from the first TRP.

Therefore, the second TRP may receive the preamble from the MS through the predetermined time and frequency resource. The second TRP may transmit a RAR message to the MS based on the preamble received from the MS. Information on a TA group ID may be transmitted as being configured in the RAR message transmitted by the second TRP to the MS.

Referring to the case of FIG. 6, if the first TRP is a TRP included in the SSB group #0 and the second TRP is a TRP included in the SSB group #1, the TA group ID included in the RAR message transmitted by the second TRP to the MS may have a different value from a TA group ID of the first TRP.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a mobile station (MS), comprising:
receiving a first synchronization signal block (SSB) including a physical broadcast channel (PBCH) from a first transmission and reception point (TRP);
receiving a system information block (SIB1) based on a master information block (MIB) included in the PBCH;
receiving second system information based on the SIB1; and
performing a random access (RA) procedure with the first TRP based on the second system information,
wherein the second system information includes information on SSB group(s) and mapping information of an SSB group to which the first TRP belongs, and the information on the SSB group(s) includes information on an SSB index transmitted by TRP(s) belonging to each of the SSB group(s).

2. The method according to claim 1, wherein the second system information further includes information on a timing advance (TA) offset for each of the SSB group(s).

3. The method according to claim 1, further comprising:
receiving a radio resource control (RRC) configuration message from the first TRP; and
transmitting an RRC configuration complete message to the first TRP in response to the RRC configuration message,
wherein the RRC configuration message includes SSB group mapping relationship information for the first TRP and adjacent TRPs.

4. The method according to claim 3, wherein the RRC configuration message further includes information on a TA offset for each of the SSB group(s).

5. The method according to claim 1, further comprising:
receiving a measurement report request message from the first TRP;
measuring reception signal strength(s) of signal(s) received from TRP(s) adjacent to the first TRP based on the measurement report request message;
transmitting, to the first TRP, a measurement report message including the measured reception signal strength(s) of the signal(s) received from the adjacent TRP(s) and information of the adjacent TRP(s);
receiving, from the first TRP, a physical downlink control channel (PDCCH) order instructing to connection to a second TRP, which is one of the adjacent TRP(s); and
performing an RA procedure with the second TRP based on the PDCCH order.

6. The method according to claim 5, wherein the information on the adjacent TRP(s) includes at least one of information on cell(s) of the adjacent TRP(s), information on SSB group(s) of the adjacent TRP(s), or information on a difference between a time of receiving the first SSB from the first TRP and a time of receiving an SSB from each of the adjacent TRP(s).

7. The method according to claim 5, wherein the PDCCH order includes at least one of information on a resource used to access the second TRP or information on a TA offset for the second TRP.

8. The method according to claim 7, wherein in the RA procedure with the second TRP, an RA preamble is transmitted based on the information on the TA offset for the second TRP.

9. A mobile station (MS) comprising a processor, wherein the processor causes the MS to perform:
receiving a first synchronization signal block (SSB) including a physical broadcast channel (PBCH) from a first transmission and reception point (TRP);
receiving a system information block (SIB1) based on a master information block (MIB) included in the PBCH;
receiving second system information based on the SIB1; and
performing a random access (RA) procedure with the first TRP based on the second system information,
wherein the second system information includes information on SSB group(s) and mapping information of an SSB group to which the first TRP belongs, and the information on the SSB group(s) includes information on an SSB index transmitted by TRP(s) belonging to each of the SSB group(s).

10. The MS according to claim 9, wherein the second system information further includes information on a timing advance (TA) offset for each of the SSB group(s).

11. The MS according to claim 9, wherein the processor causes the MS to perform:
receiving a radio resource control (RRC) configuration message from the first TRP; and
transmitting an RRC configuration complete message to the first TRP in response to the RRC configuration message,
wherein the RRC configuration message includes SSB group mapping relationship information for the first TRP and adjacent TRPs.

12. The MS according to claim 11, wherein the RRC configuration message further includes information on a TA offset for each of the SSB group(s).

13. The MS according to claim 9, wherein the processor causes the MS to perform:
receiving a measurement report request message from the first TRP;
measuring reception signal strength(s) of signal(s) received from TRP(s) adjacent to the first TRP based on the measurement report request message;
transmitting, to the first TRP, a measurement report message including the measured reception signal strength(s) of the signal(s) received from the adjacent TRP(s) and information of the adjacent TRP(s);
receiving, from the first TRP, a physical downlink control channel (PDCCH) order instructing to connection to a second TRP, which is one of the adjacent TRP(s); and
performing an RA procedure with the second TRP based on the PDCCH order.

14. The MS according to claim 13, wherein the information on the adjacent TRP(s) includes at least one of information on cell(s) of the adjacent TRP(s), information on SSB group(s) of the adjacent TRP(s), or information on a difference between a time of receiving the first SSB from the first TRP and a time of receiving an SSB from each of the adjacent TRP(s).

15. The MS according to claim 14, wherein the PDCCH order includes at least one of information on a resource used to access the second TRP or information on a TA offset for the second TRP.

16. The MS according to claim 15, wherein in the RA procedure with the second TRP, the processor causes the MS to perform: transmitting an RA preamble based on the information on the TA offset for the second TRP.

17. A method of a base station (BS), comprising:
transmitting a first synchronization signal block (SSB) including a physical broadcast channel (PBCH) through a first transmission and reception point (TRP) connected to the BS;
transmitting a system information block (SIB1) based on a master information block (MIB) included in the PBCH;
transmitting second system information based on the SIB1; and
performing a random access (RA) procedure with a mobile station (MS) in an RA occasion based on the second system information,
wherein the second system information includes information on SSB group(s) and mapping information of an SSB group to which the first TRP belongs, and the information on the SSB group(s) includes information on an SSB index transmitted by TRP(s) belonging to each of the SSB group(s).

18. The method according to claim 17, wherein the second system information further includes information on a timing advance (TA) offset for each of the SSB group(s), and a radio resource control (RRC) configuration message includes SSB group mapping relationship information for the first TRP and adjacent TRPs.

19. The method according to claim 17, further comprising:
transmitting a radio resource control (RRC) configuration message to the MS through the first TRP; and
in response to the RRC configuration message, receiving an RRC configuration complete message from the MS through the first TRP,
wherein the RRC configuration message further includes information on a TA offset for each of the SSB group(s).

20. The method according to claim 17, further comprising:
transmitting a measurement report request message to the MS through the first TRP;
receiving a measurement report message from the MS through the first TRP; and
transmitting a physical downlink control channel (PDCCH) order instructing the MS to connect to a second TRP through the first TRP based on the measurement report message,
wherein the measurement report message includes information on adjacent TRP(s) of the first TRP and information on signal strength(s) of signal(s) received from the adjacent TRP(s), and the information on the adjacent TRP(s) includes at least one of information on cell(s) of the adjacent TRP(s), information on SSB group(s) of the adjacent TRP(s), or information on a difference between a time of receiving the first SSB from the first TRP and a time of receiving an SSB from each of the adjacent TRP(s).
